(19) United States
(12) Patent Application Publication
(10) Pub. No.: US 2007/0088124 A1
(43) Pub. Date: Apr. 19, 2007

(54) Thermoplastic resin composition

(76) Inventors: Masanori Sera, Chiba (JP); Yutaka Minami, Chiba (JP); Masami Kanamaru, Chiba (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/511,099

(22) PCT Filed: Apr. 15, 2003
(86) PCT No.: PCT/JP03/04760

§ 371 Date: Jun. 9, 2005

(30) Foreign Application Priority Data
Apr. 16, 2002 (JP) 2002-113797

(51) Int. Cl. C08L 23/00; C08L 21/00; B32B 27/00

(52) U.S. Cl. 525/55; 525/191

(57) ABSTRACT

The present invention relates to a thermoplastic resin composition, which contains 0.1 to 99.9% by mass of a thermoplastic resin (1) and 0.1 to 99.9% by mass of a higher α-olefin polymer (3) containing 50 mol % or more of an α-olefin having 10 or more carbon atoms, or contains 0.1 to 99.9% by mass of a thermoplastic resin (1), more than 0% to not more than 99.8% by mass of an elastomer (2), and 0.1 to 99.9% by mass of a higher α-olefin polymer (3) containing 50 mol % or more of an α-olefin having 10 or more carbon atoms, and a molded article, a sheet, and a film produced from the composition. The composition has excellent mechanical properties including high elastic modulus and impact resistant strength, without impairing heat resistance and mold workability.

### TECHNICAL FIELD

The present invention relates to a thermoplastic resin composition, which is suitable for extrusion molding, thermoforming, injection molding, etc. and useful in many fields of various industrial materials, car bumpers, interior and exterior parts of automobiles such as trims and instrument panels, sheets, wrapping films, vessels, parts of electrical and electronic devices, parts of household electric appliances such as housings, and hollow vessels, etc., and a molded article, a sheet, and a film obtained from the composition.

### BACKGROUND ART

Weight reduction of various parts has been an important subject in recent years from the viewpoints of resource saving and energy saving, and resins are actively used for the parts instead of metals.

Particularly thermoplastic resins are inexpensive, excellent in moldability, lightweight, and excellent in mechanical strength and durability, whereby the applications of the thermoplastic resins have expanded in various fields, mainly in the fields of automobiles and household electric appliances, depending on their physical properties and economic values.

These thermoplastic resins cannot singly meet diversified requirements of the marketplace, and polymer alloys using a plurality of the thermoplastic resins in combination have been widely used.

Further, there have been attempts to add various reinforcing agents to the thermoplastic resins to increase strength and rigidity.

For example, polypropylenes including homopolymers and copolymers of propylene are lightweight and excellent in mechanical strength, chemical resistance, and weather resistance, etc., and thereby have been widely used in various fields.

However, the polypropylenes are difficult to attain well-balanced physical properties, and are not necessarily suitable for applications requiring both of excellent impact resistance and excellent rigidity and mechanical strength simultaneously.

The impact resistance of a polypropylene can be increased by blending an elastomer such as an amorphous ethylene-propylene copolymer.

However, even by increasing the amount of the elastomer, the ductility and the impact resistance cannot be efficiently increased. A larger amount of the elastomer is blended to achieve a certain level of the impact resistance, which results in poor rigidity.

This is a result from poor miscibility between the polypropylene and the elastomer.

Polymerizations of higher α-olefins having 10 or more carbon atoms have been studied, and Ziegler-Natta catalysts are mainly used in the studies.

For example, the polymerization studies are described in Polymer J., 10, 619 (1978); Macromol. Chem., 190, 2683 (1989); Makromol. Chem., Rapid Comm., 13, 447 (1992); Japanese Patent Application Laid-Open (Kokai) No. 7-145205; etc.

However, some of the higher α-olefin polymer products described in these references have low molecular weights, some have high melting points caused by high regularity, or some show 2 melting points caused by nonuniformity.

Further, production of higher α-olefin polymers by using homogeneous catalysts called as metallocene catalysts are described in Macromol. Sci. Pure Appl. Chem., A35, 473 (1998), J. Polym. Sci. A, 38, 233 (2000), Macromol. Mater. Eng., 286, 480 (2001), and Macromol. Mater. Eng., 286, 350 (2001).

However, also some of these polymers have insufficiently high molecular weights, some have high melting points caused by high regularity, or some show 2 melting points caused by nonuniformty, similarly to the above polymers produced by using the heterogeneous catalysts.

A plurality of melting points means that the crystal sizes etc. are not uniform, which does not only make the polymers poor in transparency but also make it sticky.

Further, when the polymers are mixed with another material as modifiers, the blends are not uniform, thereby often failing to achieve desired improvement in physical properties.

An object of the present invention is to provide a thermoplastic resin composition excellent in balance of rigidity and mechanical strength, which is obtained by improving the mechanical strength, particularly the impact resistance, of a thermoplastic resin without deteriorating the essential excellent heat resistance and workability, and a molded article, a sheet, and a film produced from the composition.

### DISCLOSURE OF THE INVENTION

As a result of intense research in view of the above object, the inventors have found that a higher α-olefin polymer (3) containing 50 mol % or more of an α-olefin having 10 or more carbon atoms, produced by using a particular metallocene catalyst, has a sufficient molecular weight, a narrow molecular weight distribution, and a moderately controlled regularity which causes one melting point, to be more uniform than polymers produced by using conventional catalysts, and is excellent in miscibility to other thermoplastic resins and thereby can act as a miscibility improver between a thermoplastic resin and an elastomer. The present invention has been accomplished by the finding.

Namely, the invention provides:

1. A thermoplastic resin composition comprising a thermoplastic resin (1) in an amount of 0.1 to 99.9% by mass and a higher α-olefin polymer (3) containing 50 mol % or more of an α-olefin having 10 or more carbon atoms in an amount of 0.1 to 99.9% by mass.

2. A thermoplastic resin composition comprising a thermoplastic resin (1) in an amount of 0.1 to 99.9% by mass, an elastomer (2) in an amount of exceeding 0% by mass and up to 99.8% by mass, and a higher α-olefin polymer (3) containing 50 mol % or more of an α-olefin having 10 or more carbon atoms in an amount of 0.1 to 99.9% by mass.

3. The thermoplastic resin composition according to the foregoing item 1 or item 2 described above, wherein the higher α-olefin polymer (3) has a stereoregularity index M2 of 50 mol % or more.

4. The thermoplastic resin composition according to the foregoing item 1 or item 2 described above, wherein the higher α-olefin polymer (3) has a weight average molecular weight (Mw) of 1,000 to 10,000,000 and a molecular weight distribution (Mw/Mn) of 4.0 or less, measured by the GPC method.

5. The thermoplastic resin composition according to the foregoing item 1 or item 2 described above, wherein the higher α-olefin polymer (3) has one melting point (Tm) of 0 to 100° C.

6. The thermoplastic resin composition according to the foregoing item 1 or item 2, wherein the higher α-olefin polymer (3) is obtained by polymerizing the α-olefin having 10 or more carbon atoms in the presence of a polymerization catalyst component comprising a transition metal compound (A) represented by the following general formula (I), and at least one component (B) selected from a compound (B-1) capable of reacting with the transition metal compound (A) component or a derivative thereof to form an ionic complex and an aluminoxane compound (B-2): 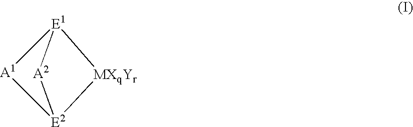
wherein M represents a metal atom among Groups 3 to 10 and the lanthanum series of the Periodic Table; E¹ and E² are ligands selected from the group of a substituted cyclopentadienyl group, an indenyl group, a substituted indenyl group, a heterocyclopentadienyl group, a substituted heterocyclopentadienyl group, an amide group, a phosphide group, a hydrocarbon group, or a silicon-containing group which form a structure cross-linked through A¹ and A² and they may be the same or different; X represents a σ-bonding ligand which may be a plurality of the same or different X's, and X may be cross-linked with another X, E¹, E², or Y;

Y represents a Lewis base, which may be a plurality of the same or different Y's, and Y may be cross-linked with another Y, E¹, E², or X; A¹ and A² are the same or different divalent cross-linking groups for linking the 2 ligands, and independently represent a hydrocarbon group having 1 to 20 carbon atoms, a halogen-containing hydrocarbon group having 1 to 20 carbon atoms, a silicon-containing group, a germanium-containing group, a tin-containing group, —O—, —CO—, —S—, —SO₂—, —Se—, —NR¹—, —PR¹—, —P(O)R¹—, —BR¹—, or —AlR¹—, in which R¹ represents a hydrogen atom, a halogen atom, a hydrocarbon group having 1 to 20 carbon atoms, or a halogen-containing hydrocarbon group having 1 to 20 carbon atoms which may be the same or different;

q represents an integer of 1 to 5 of [(valence of M)−2]; and r represents an integer of 0 to 3.

7. A molded article comprising the thermoplastic resin composition according to the foregoing item 1 or item 2 described above.

8. A sheet or a film comprising the thermoplastic resin composition according to the foregoing item 1 or item 2 described above.

### BEST MODE FOR CARRYING OUT THE INVENTION

The present invention is described in detail below.

Examples of the thermoplastic resins (1) used in the invention include olefin polymers (1A) other than the elastomer (2) which are polyolefin-based resins such as α-olefin homopolymers, α-olefin copolymers, α-olefin-vinyl monomer copolymers, ethylene-unsaturated carboxylic acid ester copolymers, and ethylene-unsaturated carboxylic acid ester copolymers; polystyrene-based resins such as polystyrenes, rubber-reinforced polystyrenes (HIPS), isotactic polystyrenes, and syndiotactic polystyrenes; polyacrylonitrile-based resins such as acrylonitrile-styrene resins (AS) and acrylonitrile-butadiene-styrene resins (ABS); polymethacrylate-based resins; polyamide-based resins; polyester-based resins; polycarbonate-based resins; polyphenylene-based resins; polyphenylene ether-based resins; polyphenylene sulfide-based resins; polyphenylene sulfone-based resins; and petroleum resins.

The olefin polymers (1A) described above include homopolymers of an olefin and copolymers of 2 or more olefins.

Specific examples of the olefin polymers (1A) include crystalline polypropylenes, propylene-α-olefin random copolymers, propylene-α-olefin block copolymers, high- or medium-density polyethylenes, polybutene-1, poly-4-methyl-pentene-1, high-pressure method low-density polyethylenes, linear low-density polyethylenes, and ultra-low-density polyethylenes, etc.

Specific examples of the olefins include α-olefins having 2 to 20 carbon atoms such as ethylene, propylene, 1-butene, 1-pentene, 1-hexene, 4-methyl-1-pentene, 3-methyl-1-pentene, 1-octene, 3-methyl-1-butene, 1-decene, 1-dodecene, 1-tetradecene, 1-hexadecene, 1-octadecene, and 1-eicocene, and cyclic olefins having 3 to 20 carbon atoms such as cyclopentene, cycloheptene, norbornene, 5-ethyl-2-norbornene, tetracyclododecene, and 2-ethyl-1,4,5,8-dimethano-1,2,3,4,4a,5,8,8a-octahydronaphthalene.

The specific examples further include styrene, vinylcyclohexane, dienes, etc.

The olefin polymer (1A) is preferably a polymer comprising olefins having 2 to 6 carbon atoms as main units, more preferably a polymer comprising propylene units as main units (a propylene polymer), and particularly preferably a propylene homopolymer.

In a case where the olefin polymer (1A) comprises an α-olefin having 10 or more carbon atoms, the olefin polymer (1A) comprises 50 mol % or more of a comonomer other than the α-olefin having 10 or more carbon atoms.

In the case of using a propylene polymer as the olefin polymer (1A), the content of units derived from propylene is preferably 80 to 100 mol %, more preferably 90 to 100 mol %, further preferably 92 to 100 mol %, the content of units derived from ethylene is preferably 0 to 10 mol %, more preferably 0 to 8 mol %, further preferably 0 to 6 mol %, and the content of units derived from an olefin selected from olefins having 4 to 12 carbon atoms is preferably 0 to 15 mol %, more preferably 0 to 10 mol %, further preferably 0 to 5 mol %.

The olefin polymer (1A) may comprise, in addition to the units described above, 5 mol % or less of a unit derived from an olefin having a branched structure such as 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, allylnaphthalene, allylnorbornane, styrene, dimethyl-styrenes, vinylnaphthalenes, allyltoluenes, allylbenzene, vinylcyclohexane, vinylcyclopentane, and vinylcycloheptane, or a unit derived from a diene compound having 4 to 20 carbon atoms such as 1,3-butadiene, 1,3-pentadiene, 1,4-pentadiene, 1,3-hexadiene, 1,4-hexadiene, 1,5-hexadiene, 4-methyl-1,4-hexadiene, 5-methyl-1,4-hexadiene, 6-methyl-1,6-octadiene, 7-methyl-1,6-octadiene, 6-ethyl-1,6-octadiene, 6-propyl-1,6-octadiene, 6-butyl-1,6-octadiene, 6-methyl-1,6-octadiene, 7-methyl-1,6-octadiene, 6-ethyl-1,6-octadiene, 7-ethyl-1,6-nonadiene, 6-methyl-1,6-decadiene, 7-methyl-1,6-decadiene, 6-methyl-1,6-undecadiene, 1,7-octadiene, 1,9-decadiene, isoprene, butadiene, ethylidene norbornene, vinylnorbornene, and dicyclopentadiene.

The intrinsic viscosity [η] of the olefin polymer (1A), measured in tetralin at 135° C., is preferably 0.5 to 10 dL/g, more preferably 1.5 to 3.5 dL/g.

The thermoplastic resins (1) may be used alone or in combination of two or more.

The elastomer (2) may be a substance with rubber elasticity such as an olefin-based elastomer and a styrene-based thermoplastic elastomer.

Examples of the olefin-based elastomers include elastomers produced by copolymerizing an α-olefin such as ethylene, propylene, 1-butene, 1-pentene, and 1-octene; elastomers produced by copolymerizing the α-olefin with a cyclic olefin, a styrene monomer, or an unconjugated diene; and so-called plastomers.

Though the plastomers and the elastomers generally have a density of 0.91 g/cm³ or less, the elastomer (2) used in the invention is not limited to the density as long as it has rubber elasticity. The elastomer (2) may be chemically cross-linked or not cross-linked.

Examples of the unconjugated dienes include dicyclopentadiene, 1,4-hexadiene, dicyclooctadiene, methylene norbornene, 5-ethylidene-2-norbornene, etc.

Specific examples of the olefin-based elastomers include amorphous elastic copolymers mainly composed of olefins such as ethylene-propylene copolymer elastomers, ethylene-1-butene copolymer elastomers, ethylene-propylene-1-butene copolymer elastomers, ethylene-1-hexene copolymer elastomers, ethylene-1-octene copolymer elastomers, ethylene-styrene copolymer elastomers, ethylene-norbornene copolymer elastomers, propylene-1-butene copolymer elastomers, ethylene-propylene-unconjugated diene copolymer elastomers, ethylene-1-butene-unconjugated diene copolymer elastomers, and ethylene-propylene-1-butene-unconjugated diene copolymer elastomers.

Among these olefin-based elastomers, polymers comprising olefins having 2 to 8 carbon atoms as main units are preferred, copolymers comprising ethylene units as main units are more preferred, and ethylene-octene copolymers are particularly preferred.

The melt flow rate (MFR) of the olefin-based elastomer measured at 230° C. under a load of 2.16 kg (21.2 N) is preferably 0.01 to 50 g/10 minutes, more preferably 0.01 to 10 g/10 minutes, further preferably 0.01 to 5 g/10 minutes.

Examples of the styrene-based thermoplastic elastomers include block copolymers of styrene-based compounds and conjugated diene compounds, and hydrogenated derivatives thereof.

Examples of the styrene-based compounds include styrene; alkylstyrenes such as α-methylstyrene, p-methylstyrene, and p-t-butylstyrene; p-methoxystyrene; vinylnaphthalene; etc.

Styrene is preferred among them.

Examples of the conjugated diene compounds include butadiene, isoprene, piperylene, methylpentadiene, phenyl-butadiene, 3,4-dimethyl-1,3-hexadiene, 4,5-diethyl-1,3-octadiene, etc.

Preferred among them are butadiene and isoprene.

The molecular structure of the styrene-based thermoplastic elastomer may be a linear structure, a branched structure, a radial structure, or a combination thereof.

Specific examples of the styrene-based thermoplastic elastomers include styrene-butadiene diblock copolymers, styrene-butadiene-styrene triblock copolymers, styrene-isoprene diblock copolymers, styrene-isoprene-styrene triblock copolymers, hydrogenated derivatives of styrene-butadiene diblock copolymers, hydrogenated derivatives of styrene-butadiene-styrene triblock copolymers, hydrogenated derivatives of styrene-isoprene diblock copolymers, hydrogenated derivatives of styrene-isoprene-styrene triblock copolymers, etc.

The elastomers (2) may be used alone or in combination of two or more.

The higher α-olefin polymer (3) used in the invention is a polymer using an α-olefin having 10 or more carbon atoms as a main component, and the α-olefin preferably has 10 to 40 carbon atoms, more preferably has 10 to 26 carbon atoms.

When the α-olefin has less than 10 carbon atoms, the higher α-olefin polymer (3) is likely to be tacky and to have a reduced strength and a reduced miscibility to other resins.

The content of the α-olefin having 10 or more carbon atoms is preferably 50 to 100 mol %, more preferably 65 to 100 mol %, particularly preferably 80 to 100 mol %, further preferably 90 to 100 mol %.

When the content of the higher α-olefin having 10 or more carbon atoms is less than 50 mol %, the miscibility to the other resins is reduced.

The higher α-olefin polymer (3) used in the invention preferably has an isotactic structure, and preferably has a stereoregularity index M2 of 50 mol % or more.

The stereoregularity index M2 is more preferably 50 to 90 mol %, particularly preferably 55 to 85 mol %, further preferably 55 to 75 mol %.

Thus, the object of the invention may be achieved by controlling the stereoregularity index at the middle level or more, preferably at the middle level.

The higher α-olefin polymer (3) used in the invention preferably has the following characteristics.

Namely, when a sample of the higher α-olefin polymer (3) is kept at −30° C. for 5 minutes under nitrogen atmosphere and then heated to 190° C. at 10° C./minute to obtain a melting endotherm curve by using a differential scanning calorimeter (DSC), the higher α-olefin polymer (3) preferably has a melting point (TmD) defined as a temperature corresponding to the peak top in the melting endotherm curve. Further, when the sample is kept at 190° C. for 5 minutes, cooled to −30° C. at 5° C./minute, kept at −30° C. for 5 minutes, and then heated to 190° C. at 10° C./minute to obtain a melting endotherm curve, the higher α-olefin polymer (3) preferably shows one peak in the melting endotherm curve. The melting point (Tm) of the higher α-olefin polymer (3), which is defined as a temperature corresponding to the peak top of the one peak, is 0 to 100° C., preferably 20 to 80° C., more preferably 25 to 55° C.

The higher α-olefin polymer (3) having the above characteristics is non-tacky at ordinary temperature and excellent in storage stability and secondary workability, and can be uniformly melted at a low temperature to be excellent in workability.

The higher α-olefin polymer (3) used in the invention may be produced by using the following metallocene catalyst. The metallocene catalyst preferably comprises a C₂ or C₁, symmetric transition metal compound capable of synthesizing an isotactic polymer, particularly preferably comprises a C₂ symmetric transition metal compound.

Namely, the higher α-olefin polymer (3) is obtained by polymerizing the α-olefin having 10 or more carbon atoms in the presence of a polymerization catalyst component comprising a transition metal compound (A) represented by the following general formula (I), and at least one component (B) selected from a compound (B-1) capable of reacting with the transition metal compound of component or a derivative thereof to form an ionic complex and an aluminoxane compound (B-2): 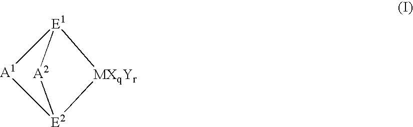
wherein M represents a metal atom among Groups 3 to 10 and the lanthanum series of the Periodic Table; E¹ and E² are ligands selected from the group of a substituted cyclopentadienyl group, an indenyl group, a substituted indenyl group, a heterocyclopentadienyl group, a substituted heterocyclopentadienyl group, an amide group, a phosphide group, a hydrocarbon group, or a silicon-containing group, which form a structure cross-linked through A¹ and A² and they may be the same or different; X represents a σ-bonding ligand which may be a plurality of the same or different X's, and X may be cross-linked with another X, E¹, E², or Y;

Y represents a Lewis base, which may be a plurality of the same or different Y's, and Y may be cross-linked with another Y, E¹, E², or X; A¹ and A² are the same or different divalent cross-linking groups for linking the 2 ligands, and independently represent a hydrocarbon group having 1 to 20 carbon atoms, a halogen-containing hydrocarbon group having 1 to 20 carbon atoms, a silicon-containing group, a germanium-containing group, a tin-containing group, —O—, —CO—, —S—, —SO₂—, —Se—, —NR¹—, —PR¹—, —P(O)R¹—, —BR¹—, or —AlR¹—, in which R¹ represents a hydrogen atom, a halogen atom, a hydrocarbon group having 1 to 20 carbon atoms, or a halogen-containing hydrocarbon group having 1 to 20 carbon atoms which may be the same or different;

q represents an integer of 1 to 5 of [(valence of M)−2]; and r represents an integer of 0 to 3.

In the above general formula (I), M represents a metal atom among Groups 3 to 10 and the lanthanum series of the Periodic Table, and specific examples thereof include titanium, zirconium, hafnium, yttrium, vanadium, chromium, manganese, nickel, cobalt, palladium, lanthanoid metals, etc. Titanium, zirconium, and hafnium are preferred among the metal atoms in view of olefin polymerization activity, etc.

E¹ and E² independently represent a ligand selected from the group consisting of substituted cyclopentadienyl groups, indenyl groups, substituted indenyl groups, heterocyclopentadienyl groups, substituted heterocyclopentadienyl groups, amide groups (—N<), phosphine groups (—P<), hydrocarbon groups (>CR— and >C<), and silicon-containing groups (>SiR— and >Si<), in which R represents a hydrogen atom, a hydrocarbon group having 1 to 20 carbon atoms, or a heteroatom-containing group. E¹ and E² form a structure cross-linked through A¹ and A².

E¹ and E² may be the same or different ligands. E¹ and E² are preferably a substituted cyclopentadienyl group, an indenyl group, or a substituted indenyl group, respectively.

X represents a α-bonding ligand. When the transition metal compound has a plurality of X's, X's may be the same or different ligands. X may be cross-linked with another X, E¹, E², or Y.

Specific examples of X include halogen atoms, hydrocarbon groups having 1 to 20 carbon atoms, alkoxy groups having 1 to 20 carbon atoms, aryloxy groups having 6 to 20 carbon atoms, amide groups having 1 to 20 carbon atoms, silicon-containing groups having 1 to 20 carbon atoms, phosphide groups having 1 to 20 carbon atoms, sulfide groups having 1 to 20 carbon atoms, and acyl groups having 1 to 20 carbon atoms, etc.

Y represents a Lewis base. When the transition metal compound has a plurality of Y's, Y's may be the same or different Lewis bases. Y may be cross-linked with another Y, E¹, E², or X.

Specific examples of the Lewis bases of Y include amines, ethers, phosphines, thioethers, etc.

A¹ and A² are the same or different divalent cross-linking groups for linking the 2 ligands, and independently represent a hydrocarbon group having 1 to 20 carbon atoms, a halogen-containing hydrocarbon group having 1 to 20 carbon atoms, a silicon-containing group, a germanium-containing group, a tin-containing group, —O—, —CO—, —S—, —SO₂—, —Se—, —NR¹—, —PR¹—, —P(O)R¹—, —BR¹—, or —AlR¹—. R¹ represents a hydrogen atom, a halogen atom, a hydrocarbon group having 1 to 20 carbon atoms, or a halogen-containing hydrocarbon group having 1 to 20 carbon atoms. Such a cross-linking group may be a group represented by the general formula: 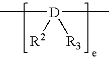
wherein D represents a carbon atom, a silicon atom, or a tin atom, R² and R³ independently represent a hydrogen atom or a hydrocarbon group having 1 to 20 carbon atoms, R² and R³ may be the same or different and may be bonded together to form a ring structure, and e represents an integer of 1 to 4. Specific examples of the cross-linking groups include a methylene group, an ethylene group, an ethylidene group, a propylidene group, an isopropylidene group, a cyclohexylidene group, a 1,2-cyclohexylene group, a vinylidene group (CH₂═C═), a dimethylsilylene group, a diphenylsilylene group, a methylphenylsilylene group, a dimethylgermylene group, a dimethylstannylene group, a tetramethyldisilylene group, a diphenyldisilylene group, etc.

Preferred among these groups are an ethylene group, an isopropylidene group, and a dimethylsilylene group.

q represents an integer of 1 to 5 of [(valence of M)−2], and r represents an integer of 0 to 3.

The transition metal compound represented by the general formula (I) is preferably a transition metal compound comprising ligands of double-cross-linking-type biscyclopentadienyl derivatives, represented by the general formula (II):

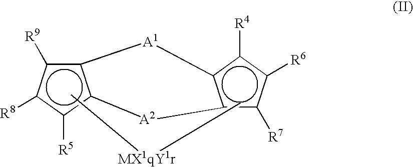

In the above general formula (II), M, A¹, A², q, and r are the same as those in the general formula (I).

X¹ represents a α-bonding ligand. When the transition metal compound has a plurality of X¹'s, X¹'s may be the same or different ligands. X¹ may be cross-linked with another X¹ or Y¹.

Specific examples of X¹ may be the same as those of X in the general formula (I).

Y¹ represents a Lewis base. When the transition metal compound has a plurality of Y¹'s, Y¹'s may be the same or different Lewis bases. Y¹ may be cross-linked with another Y¹ or X¹.

Specific examples of Y¹ may be the same as those of Y in the general formula (I).

R⁴ to R⁹ independently represent a hydrogen atom, a halogen atom, a hydrocarbon group having 1 to 20 carbon atoms, a halogen-containing hydrocarbon group having 1 to 20 carbon atoms, a silicon-containing group, or a heteroatom-containing group, and at least one of R⁴ to R⁹ is not a hydrogen atom.

R⁴ to R⁹ may be the same or different ones, and adjacent groups thereof may be bonded together to form a ring.

In particular, R⁶ and R⁷ preferably form a ring, and R⁸ and R⁹ preferably form a ring.

R⁴ and R⁵ are preferably groups containing heteroatoms such as an oxygen atom, a halogen atom, or a silicon atom in view of increasing polymerization activity.

The transition metal compound comprising the ligands of the double-cross-linking-type biscyclopentadienyl derivatives preferably has a silicon atom in the cross-linking groups between the ligands.

Specific examples of the transition metal compounds represented by the general formula (I) include (1,2′-ethylene)(2,1′-ethylene)-bis(indenyl)zirconium dichloride, (1,2′-methylene)(2,1′-methylene)-bis(indenyl)zirconium dichloride, (1,2′-isopropylidene)(2,1′-isopropylidene)-bis (indenyl)zirconium dichloride, (1,2′-ethylene)(2,1′-ethylene)-bis(3-methylindenyl)zirconium dichloride, (1,2′-ethylene)(2,1′-ethylene)-bis(4,5-benzoindenyl)zirconium dichloride, (1,2′-ethylene)(2,1′-ethylene)-bis(4-isopropy lindenyl)zirconium dichloride, (1,2′-ethylene)(2,1′-ethylene)-bis(5,6-dimethylindenyl)zirconium dichloride, (1,2′-ethylene)(2,1′-ethylene)-bis(4,7-diisopropylindenyl )zirconium dichloride, (1,2′-ethylene)(2,1′-ethylene)-bis (4-phenylindenyl)zirconium dichloride, (1,2′-ethylene) (2,1′-ethylene)-bis(3-methyl-4-isopropylindenyl)zirconium dichloride, (1,2′-ethylene)(2,1′-ethylene)-bis(5,6-benzoindenyl)zirconium dichloride, (1,2′-ethylene)(2,1′-isopropylidene)-bis(indenyl)zirconium dichloride, (1,2′-methyllene)(2,1′-ethylene)-bis(indenyl)zirconium dichloride, (1,2′-methylene)(2,1′-isopropylidene)-bis (indenyl)zirconium dichloride, (1,2′-dimethylsilylene) (2,1′-dimethylsilylene)-bis(indenyl)zirconium dichloride, (1,2′-dimethylsilylene)(2,1′-dimethylsilylene)-bis(3-methyl-indenyl)zirconium dichloride, (1,2′-dimethylsilylene)(2,1′-dimethylsilylene)-bis(3-n-butylindenyl)zirconium dichloride, (1,2′-dimethylsilylene)(2,1′-dimethylsilylene)-bis(3-i-propylindenyl)zirconium dichloride, (1,2′-dimethylsilylene)(2,1′-dimethylsilylene)-bis(3-trimethylsilylmethylindenyl)zirconium dichloride, (1,2′-dimethylsilylene)(2,1′-dimethylsilylene)-bis(3-phenylindenyl)zirconium dichloride, (1,2′-dimethylsilylene) (2,1′-dimethylsilylene)-bis(4,5-benzoindenyl)zirconium dichloride, (1,2′-dimethylsilylene) (2,1′-dimethyl silylene)-bis(4-isopropylindenyl)zirconium dichloride, (1,2′-dimethylsilylene)(2,1′-dimethylsilylene)-bis(5,6-dimethylindenyl)zirconium dichloride, (1,2′-dimethylsilylene)(2,1′-dimethylsilylene)-bis(4,7-di-1-propylindenyl)zirconium dichloride, (1,2′-dimethylsilylene) (2,1′-dimethylsilylene)-bis(4-phenylindenyl)zirconium dichloride, (1,2′-dimethylsilylene)(2,1′-dimethylsilylene)-bis(3-methyl-4-i-propylindenyl)zirconium dichloride, (1,2′-dimethylsilylene)(2,1′-dimethylsilylene)-bis(5,6-benzoindenyl)zirconium dichloride, (1,2′-dimethylsilylene)(2,1′-isopropylidene)-bis(indenyl)zirconium dichloride, (1,2′-dimethylsilylene)(2,1′-isopropylidene)-bis(3-methylindenyl)zirconium dichloride, (1,2′-dimethylsilylene) (2,1′-isopropylidene)-bis(3-i-propylindenyl)zirconium dichloride, (1,2′-dimethylsilylene)(2,1′-isopropylidene)-bis(3-n-butylindenyl)zirconium dichloride, (1,2′-dimethylsilylene)(2,1′-isopropylidene)-bis(3-trimethylsilylmethylindenyl)zirconium dichloride, (1,2′-dimethylsilylene) (2,1′-isopropylidene)-bis(3-trimethylsilylindenyl)zirconium dichloride, (1,2′-dimethylsilylene)(2,1′-isopropylidene)-bis(3-phenylindenyl)zirconium dichloride, (1,2′-dimethylsilylene)(2,1′-methylene)-bis(indenyl)zirconium dichloride, (1,2′-dimethylsilylene)(2,1′-methylene)-bis(3-methylindenyl)zirconium dichloride, (1,2′-dimethylsilylene)(2,1′-methylene)-bis(3-i-propylindenyl)zirconium dichloride, (1,2′-dimethylsilylene)(2,1′-methylene)-bis(3-n-butylindenyl)zirconium dichloride, (1,2′-dimethylsilylene)(2,1′-methylene)-bis(3-trimethylsilylmethylindenyl)zirconium dichloride, (1,2′-dimethylsilylene)(2,1′-methylene)-bis(3-trimethylsilylindenyl)zirconium dichloride, (1,2′-diphenylsilylene)(2,1′-methylene)-bis(indenyl)zirconium dichloride, (1,2′-diphenylsilylene)(2,1′-methylene)-bis(3-methylindenyl)zirconium dichloride, (1,2′-diphenylsilylene)(2,1′-methylene)-bis(3-i-propylindenyl)zirconium dichloride, (1,2′-diphenylsilylene) (2,1′-methylene)-bis(3-n-butylindenyl)zirconium dichloride, (1,2′-diphenylsilylene)(2,1′-methylene)-bis(3-trimethylsilylmethylindenyl)zirconium dichloride, (1,2′-diphenylsilylene)(2,1′-methylene)-bis(3-trimethylsilylindenyl)zirconium dichloride, (1,2′-dimethylsilylene)(2,1′-dimethylsilylene)(3-methylcyclopentadienyl)(3′-methylcyclopentadienyl)zirconium dichloride, (1,2′-dimethylsilylene)(2,1′-isopropylidene)(3-methylcyclopentadienyl)(3′-methylcyclopentadienyl)zirconium dichloride, (1,2′-dimethylsilylene)(2,1′-ethylene)(3-methylcyclopentadienyl)(3′-methylcyclopentadienyl)zirconium dichloride, (1,2′-ethylene)(2,1′-methylene)(3-methylcyclopentadienyl)(3′-methylcyclopentadienyl)zirconium dichloride, (1,2′-ethylene)(2,1′-isopropylidene)(3-methylcyclopentadienyl)(3′-methylcyclopentadienyl)zirconium dichloride, (1,2′-methylene)(2,1′-methylene)(3-methylcyclopentadienyl)(3′-methylcyclopentadienyl)zirconium dichloride, (1,2′-methylene)(2,1′-isopropylidene) (3-methylcyclopentadienyl)(3′-methylcyclopentadienyl)zirconium dichloride, (1,2′-isopropylidene)(2,1′-isopropylidene)(3-methylcyclopentadienyl)(3′-methylcyclopentadienyl)zirconium dichloride, (1,2′-dimethylsilylene)(2,1′-dimethylsilylene)(3,4-dimethylcyclopentadienyl)(3′,4′-dimethylcyclopentadienyl)zirconium dichloride, (1,2′-dimethyl silylene)(2,1′-isopropylidene)(3,4-dimethylcyclopentadienyl)(3′,4′-dimethylcyclopentadienyl)zirconium dichloride, (1,2′-dimethylsilylene)(2,1′-ethylene)(3,4-dimethylcyclopentadienyl)(3′,4′-dimethylcyclopentadienyl)zirconium dichloride, (1,2′-ethylene)(2,1′-methylene)(3,4-dimethylcyclopentadienyl)(3′,4′-dimethylcyclopentadienyl)zirconium dichloride, (1,2′-ethylene)(2,1′-isopropylidene)(3,4-dimethylcyclopentadienyl)(3′,4′-dimethylcyclopentadienyl)zirconium dichloride, (1,2′-methylene)(2,1′-methylene)(3,4-dimethylcyclopentadienyl)(3′,4′-dimethylcyclopentadienyl)zirconium dichloride, (1,2′-methylene)(2,1′-isopropylidene)(3,4-dimethylcyclopentadienyl)(3′,4′-dimethylcyclopentadienyl)zirconium dichloride, (1,2′-isopropylidene)(2,1′-isopropylidene)(3,4-dimethylcyclopentadienyl)(3′,4′-dimethylcyclopentadienyl)zirconnium dichloride, (1,2′-dimethylsilylene)(2,1′-dimethylsilylene)(3-methyl-5-ethylcyclopentadienyl)(3′-methyl-5′-ethylcyclopentadienyl)zirconium dichloride, (1,2′-dimethylsilylene)(2,1′-dimethylsilylene)(3-methyl-5-ethylcyclopentadienyl)(3′-methyl-5′-ethylcyclopentadienyl)zirconium dichloride, (1,2′-dimethylsilylene)(2,1′-dimethylsilylene)(3-methyl-5-isopropylcyclopentadienyl)(3′-methyl-5′-isopropylcyclopentadienyl)zirconium dichloride, (1,2′-dimethylsilylene)(2,1′-dimethylsilylene)(3-methyl-5-n-butylcyclopentadienyl)(3′-methyl-5′-n-butyl cyclopentadienyl)zirconium dichloride, (1,2′-dimethylsilylene)(2,1′-dimethylsilylene)(3-methyl-5-phenylcyclopentadienyl)(3′-methyl-5′-phenylcyclopentadienyl)zirconnium dichloride, (1,2′-dimethylsilylene)(2,1′-isopropylidene)(3-methyl-5-ethylcyclopentadienyl)(3′-methyl-5′-ethylcyclopentadienyl)zirconium dichloride, (1,2′-dimethylsilylene)(2,1′-isopropylidene)(3-methyl-5-i-propylcyclopentadienyl) (3′-methyl-5′-1-propylcyclopentadienyl)zirconium dichloride, (1,2′-dimethylsilylene)(2,1′-isopropylidene)(3-methyl-5-n-butylcyclopentadienyl)(3′-methyl-5′-n-butylcyclopentadienyl)zirconium dichloride, (1,2′-dimethylsilylene)(2,1′-isopropylidene)(3-methyl-5-phenylcyclopentadienyl)(3′-methyl-5′-phenylcyclopentadienyl)zirconium dichloride, (1,2′-dimethylsilylene)(2,1′-ethylene)(3-methyl-5-ethylcyclopentadienyl)(3′-methyl-5′-ethylcyclopentadienyl)zirconium dichloride, (1,2′-dimethyl silylene)(2,1′-ethylene)(3-methyl-5-i-propylcyclopentadienyl)(3′-methyl-5′-1-propylcyclopentadienyl)zirconium dichloride, (1,2′-dimethylsilylene)(2,1′-ethylene)(3-methyl-5-n-butylcyclopentadienyl) (3′-methyl-5′-n-butylcyclopentadienyl)zirconium dichloride, (1,2′-dimethylsilylene)(2,1′-ethylene)(3-methyl-5-phenylcyclopentadienyl)(3′-methyl-5′-phenylcyclopentadienyl)zirconium dichloride, (1,2′-dimethylsilylene)(2,1′-methylene)(3-methyl-5-ethylcyclopentadienyl)(3′-methyl-5′-ethylcyclopentadienyl)zirconium dichloride, (1,2′-dimethylsilylene) (2,1′-methylene)(3-methyl-5-i-propylcyclopentadienyl) (3′-methyl-5′-1-propylcyclopentadienyl)zirconium dichloride, (1,2′-dimethylsilylene)(2,1′-methylene)(3-methyl-5-n-butylcyclopentadienyl)(3′-methyl-5′-n-butylcyclopentadienyl)zirconium dichloride, (1,2′-dimethylsilylene)(2,1′-methylene)(3-methyl-5-phenylcyclopentadienyl)(3′-methyl-5′-phenylcyclopentadienyl)zirconium dichloride, (1,2′-ethylene)(2,1′-methylene)(3-methyl-5-i-propylcyclopentadienyl)(3′-methyl-5′-1-propylcyclopentadienyl)zirconium dichloride, (1,2′-ethylene)(2,1′-isopropylidene)(3-methyl-5-i-propylcyclopentadienyl)(3′-methyl-5′-1-propylcyclopentadienyl)zirconium dichloride, (1,2′-methylene)(2,1′-methylene)(3-methyl-5-i-propyl cyclopentadienyl)(3′-methyl-5′-1-propylcyclopentadienyl)zirconium dichloride, (1,2′-methylene)(2,1′-isopropylidene)(3-methyl-5-i-propylcyclopentadienyl)(3′-methyl-5′-i-propylcyclopentadienyl)zirconium dichloride, (1,2′-diphenylsilylene)(2,1′-dimethylsilylene)-bis(indenyl)zirconium dichloride, (1,2′-diisopropylsilylene) (2,1′-dimethylsilylene)-bis(indenyl)zirconium dichloride, (1,2′-diisopropylsilylene)(2,1′-diisopropylsilylene)-bis (indenyl)zirconium dichloride, (1,2′-dimethylsilylene) (2,1′-dimethylsilylene)(indenyl)(3-trimethylsilylindenyl)zirconium dichloride, (1,2′-diphenylsilylene)(2,1′-diphenylsilylene)(indenyl)(3-trimethylsilylindenyl)zirconium dichloride, (1,2′-diphenylsilylene)(2,1′-dimethylsilylene)(indenyl)(3-trimethylsilylindenyl)zirconium dichloride, (1,2′-dimethylsilylene)(2,1′-diphenylsilylene)(indenyl)(3-trimethylsilylindenyl)zirconium dichloride, (1,2′-diisopropylsilylene)(2,1′-dimethylsilylene)(indenyl)(3-trimethylsilylindenyl)zirconium dichloride, (1,2′-dimethylsilylene)(2,1′-diisopropylsilylene)(indenyl)(3-trimethylsilylindenyl)zirconium dichloride, (1,2′-diisopropylsilylene)(2,1′-diisopropylsilylene)(indenyl)(3-trimethylsilylindenyl)zirconium dichloride, (1,2′-dimethylsilylene)(2,1′-dimethylsilylene)(indenyl)(3-trimethylsilylmethylindenyl)zirconium dichloride, (1,2′-diphenylsilylene)(2,1′-diphenylsilylene)(indenyl)(3-trimethylsilylmethylindenyl)zirconium dichloride, (1,2′-diphenylsilylene)(2,1′-dimethylsilylene)(indenyl)(3-trimethylsilylmethylindenyl)zirconium dichloride, (1,2′-dimethylsilylene)(2,1′-diphenylsilylene)(indenyl)(3-trimethylsilylmethylindenyl)zirconium dichloride, (1,2′-diisopropylsilylene)(2,1′-dimethylsilylene)(indenyl)(3-trimethylsilylmethylindenyl)zirconium dichloride, (1,2′-dimethylsilylene)(2,1′-diisopropylsilylene)(indenyl)(3-trimethylsilylmethylindenyl)zirconium dichloride, (1,2′-diisopropylsilylene) (2,1′-diisopropylsilylene)(indenyl)(3-trimethylsilylmethylindenyl)zirconium dichloride, and compounds provided by replacing zirconium thereof with titanium or hafnium. The transition metal compound is not limited thereto.

Further, the specific examples of the transition metal compounds represented by the general formula (I) include compounds similar to the above ones comprising a metal atom of the other Groups or the lanthanum series.

In the above compounds, the (1,1′-) (2,2′-) structures may be changed to (1,2′-)(2,1′-) structures, and the (1,2′-)(2,1′-) structures may be changed to (1,1′-)(2,2′-) structures.

The transition metal compounds preferably have (1,2′-) (2,1′-) structures.

The compound (B-1) of the component (B) may be any compound that can be reacted with the transition metal compound of the component (A) to form an ionic complex. The compound (B-1) is preferably represented by the following general formula (III) or (IV):
([L¹-R¹⁰]^{k+})ₐ([Z]⁻)_{b} (III)
([L²]^{k+})ₐ([Z]⁻)_{b} (IV)
wherein L² is M², R¹¹R¹²M³, R¹³₃C, or R¹⁴M³.

In the general formulae (III) and (IV), L¹ represents a Lewis base. [Z]⁻ represents a non-coordinating anion [Z¹]⁻ or [Z²]⁻, where [Z¹]⁻ represents an anion [M¹G¹G² . . . G^{f}]⁻ comprising an element and a plurality of groups bonded thereto. In [M¹G¹G² . . . G^{f}]⁻, M¹ represents an element of Groups 5 to 15 of the Periodic Table, preferably an element of Groups 13 to 15 of the Periodic Table.

G¹ to G^{f} independently represent a hydrogen atom, a halogen atom, an alkyl group having 1 to 20 carbon atoms, a dialkylamino group having 2 to 40 carbon atoms, an alkoxy group having 1 to 20 carbon atoms, an aryl group having 6 to 20 carbon atoms, an aryloxy group having 6 to 20 carbon atoms, an alkylaryl group having 7 to 40 carbon atoms, an arylalkyl group having 7 to 40 carbon atoms, a halogen-substituted hydrocarbon group having 1 to 20 carbon atoms, an acyloxy group having 1 to 20 carbon atoms, an organometalloid group, or a heteroatom-containing hydrocarbon group having 2 to 20 carbon atoms. Two or more of G¹ to G^{f} may form a ring.

f represents an integer of [(valence of central metal M¹)+1]. [Z²]⁻ represents a conjugate base of a Broensted acid having a logarithm of reciprocal of acid dissociation constant (pKa) of −10 or less, a conjugate base of a combination of a Broensted acid and a Lewis acid, or a conjugate base of a so-called superstrong acid. [Z²]⁻ may be coordinated with a Lewis base.

R¹⁰ represents a hydrogen atom, an alkyl group having 1 to 20 carbon atoms, an aryl group having 6 to 20 carbon atoms, an alkylaryl group, or an arylalkyl group, R¹¹ and R¹² independently represent a cyclopentadienyl group, a substituted cyclopentadienyl group, an indenyl group, or a fluorenyl group, R¹³ represents an alkyl group having 1 to 20 carbon atoms, an aryl group, an alkylaryl group, or an arylalkyl group.

R¹⁴ represents a macrocyclic ligand such as tetraphenylporphyrin and phthalocyanine.

k represents an integer of 1 to 3, which is an ionic valence of [L¹-R¹⁰] and [L²]. a represents an integer of 1 or more, and b=(k×a)

M² comprises an element of Groups 1 to 3, 11 to 13, and 17 of the Periodic Table, and M³ represents an element of Groups 7 to 12 of the Periodic Table.

Specific examples of L¹ include amines such as ammonia, methylamine, aniline, dimethylamine, diethylamine, N-methylaniline, diphenylamine, N,N-dimethylaniline, trimethylamine, triethylamine, tri-n-butylamine, methyldiphenylamine, pyridine, p-bromo-N,N-dimethylaniline, and p-nitro-N,N-dimethylaniline; phosphines such as triethylphosphine, triphenylphosphine, and diphenylphosphine; thioethers such as tetrahydrothiophene; esters such as ethyl benzoate; nitriles such as acetonitrile and benzonitrile; etc.

Specific examples of R¹⁰ include a hydrogen atom, a methyl group, an ethyl group, a benzyl group, a trityl group, etc. Specific examples of R¹¹ and R¹² include a cyclopentadienyl group, a methylcyclopentadienyl group, an ethylcyclopentadienyl group, a pentamethylcyclopentadienyl group, etc.

Specific examples of R¹³ include a phenyl group, a p-tolyl group, a p-methoxyphenyl group, etc., and specific examples of R¹⁴ include tetraphenylporphyrin, phthalocyanine, an allyl group, a methallyl group, etc.

Specific examples of M² include Li, Na, K, Ag, Cu, Br, I, I₃, etc., and specific examples of M³ include Mn, Fe, Co, Ni, Zn, etc.

In [Z¹]⁻, namely [M¹G¹G² . . . G^{f}]⁻, specific examples of M¹ include B, Al, Si, P, As, Sb, etc. M¹ is preferably B or Al.

Specific examples of G¹, G² to G^{f} include dialkylamino groups such as a dimethylamino group and a diethylamino group; alkoxy and aryloxy groups such as a methoxy group, an ethoxy group, a n-butoxy group, and a phenoxy group; hydrocarbon groups such as a methyl group, an ethyl group, a n-propyl group, an isopropyl group, a n-butyl group, an isobutyl group, a n-octyl group, a n-eicosyl group, a phenyl group, a p-tolyl group, a benzyl group, a 4-t-butylphenyl group, and a 3,5-dimethylphenyl group; halogen atoms such as a fluorine atom, a chlorine atom, a bromine atom, and an iodine atom; heteroatom-containing hydrocarbon groups such as a p-fluorophenyl group, a 3,5-difluorophenyl group, a pentachlorophenyl group, a 3,4,5-trifluorophenyl group, a pentafluorophenyl group, a 3,5-bis(trifluoromethyl)phenyl group, and a bis(trimethylsilyl)methyl group; organometaloid groups such as a pentamethylantimony group, a trimethylsilyl group, a trimethylgermyl group, a diphenylarsine group, a dicyclohexylantimony group, and diphenylboron group; etc.

Specific examples of the non-coordinating anion [Z²]⁻, namely the conjugate base of a Broensted acid having pKa of −10 or less or a combination of a Broensted acid and a Lewis acid, include trifluoromethanesulfonate anion (CF₃SO₃)⁻, bis(trifluoromethanesulfonyl)methyl anion, bis(trifluoromethanesulfonyl)benzyl anion, bis(trifluoromethanesulfonyl)amide, perchlorate anion (ClO₄)⁻, trifluoroacetate anion (CF₃CO₂)⁻, hexafluoroantimony anion (SbF₆)⁻, fluorosulfonate anion (FSO₃)⁻, chlorosulfonate anion (ClSO₃)⁻, fluorosulfonate anion/antimony pentafluoride (FSO₃/SbF₅)⁻, fluorosulfonate anion/arsenic pentafluoride (FSO₃/AsF₅)⁻, trifluoromethanesulfonate anion/antimony pentafluoride (CF₃SO₃/SbF₅)⁻, etc.

Specific examples of the ionic compounds (B-1) capable of reacting with the transition metal compound of component (A) described above to form an ionic complex include triethylammonium tetraphenylborate, tri-n-butylammonium tetraphenylborate, trimethylammonium tetraphenylborate, tetraethylammonium tetraphenylborate, methyl(tri-n-butyl)ammonium tetraphenylborate, benzyl(tri-n-butyl)ammonium tetraphenylborate, dimethyldiphenylammonium tetraphenylborate, triphenyl(methyl)ammonium tetraphenylborate, trimethylanilinium tetraphenylborate, methylpyridinium tetraphenylborate, benzylpyridinium tetraphenylborate, methyl(2-cyanopyridinium)tetraphenylborate, triethylammonium tetrakis(pentafluorophenyl)borate, tri-n-butylammonium tetrakis(pentafluorophenyl)borate, triphenylammonium tetrakis(pentafluorophenyl)borate, tetra-n-butylammonium tetrakis(pentafluorophenyl)borate, tetraethylammonium tetrakis(pentafluorophenyl)borate, benzyl(tri-n-butyl)ammonium tetrakis(pentafluorophenyl)borate, methyldiphenylammonium tetrakis(pentafluorophenyl)borate, triphenyl(methyl)ammonium tetrakis(pentafluorophenyl)borate, methylanilinium tetrakis(pentafluorophenyl)borate, dimethylanilinium tetrakis(pentafluorophenyl)borate, trimethylanilinium tetrakis(pentafluorophenyl)borate, methylpyridinium tetrakis(pentafluorophenyl)borate, benzylpyridinium tetrakis(pentafluorophenyl)borate, methyl(2-cyanopyridinium) tetrakis(pentafluorophenyl)borate, benzyl(2-cyanopyridinium)tetrakis(pentafluorophenyl)borate, methyl(4-cyanopyridinium)tetrakis(pentafluorophenyl)borate, triphenylphosphonium tetrakis(pentafluorophenyl)borate, dimethylanilinium tetrakis[bis(3,5-di-trifluoromethyl)phenyl]borate, ferrocenium tetraphenylborate, silver tetraphenylborate, trityl tetraphenylborate, tetraphenylporphyrin manganese tetraphenylborate, ferrocenium tetrakis(pentafluorophenyl)borate, 1,1′-dimethylferrocenium tetrakis(pentafluorophenyl)borate, decamethylferrocenium tetrakis(pentafluorophenyl)borate, silver tetrakis(pentafluorophenyl)borate, trityl tetrakis(pentafluorophenyl)borate, lithium tetrakis(pentafluorophenyl)borate, sodium tetrakis(pentafluorophenyl)borate, tetraphenylporphyrin manganese tetrakis(pentafluorophenyl)borate, silver tetrafluoroborate, silver hexafluorophosphate, silver hexafluoroarsenate, silver perchlorate, silver trifluoroacetate, silver trifluoromethanesulfonate, etc.

The compound (B-1) may be used alone or in combination of two or more.

The aluminoxane compound of may be a chain aluminoxane compound represented by the general formula (V): 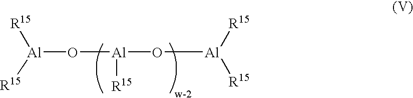
wherein R¹⁵'s independently represent a hydrocarbon group such as an alkyl group, an alkenyl group, an aryl group, and an arylalkyl group, which has 1 to 20 carbon atoms and preferably has 1 to 12 carbon atoms, or a halogen atom, w represents an average polymerization degree, which is generally an integer of 2 to 50, preferably an integer of 2 to 40, and R¹⁵'s may be the same or different ones.

The compound (B-2) may also be a cyclic aluminoxane compound represented by the general formula (VI): 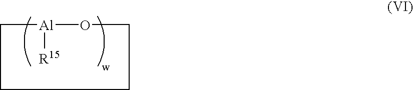
wherein R¹⁵ and w are the same as those in the general formula (V).

The aluminoxane compound may be produced by bringing an alkylaluminum into contact with a condensing agent such as water. The aluminoxane compound may be produced by a known method without particular limitations.

For example, the aluminoxane compound may be produced by (i) a method of dissolving an organoaluminum compound in an organic solvent and contacting the resultant solution with water; (ii) a method of adding an organoaluminum compound before the polymerization and then adding water; (iii) a method of reacting an organoaluminum compound with water of crystallization in a metal salt, etc. or adsorbed water of an inorganic or organic compound; (iv) a method of reacting a trialkylaluminum with a tetraalkyldialuminoxane and then with water; etc.

The aluminoxane compound may be insoluble in toluene.

These aluminoxane compounds may be used alone or in combination of two or more.

In the case of using the compound (B-1) as the catalyst component (B), the mole ratio of the catalyst component (A) to the catalyst component (B) is preferably 10:1 to 1:100, more preferably 2:1 to 1:10. When the mole ratio is without the range, the catalyst cost per unit mass of the polymer is increased to be not practical.

In the case of using the compound (B-2) as the catalyst component (B), the mole ratio of the catalyst component (A) to the catalyst component (B) is preferably 1:1 to 1:1,000,000, more preferably 1:10 to 1:10,000.

When the mole ratio is without the range, the catalyst cost per unit weight of the polymer is increased to be not practical.

The compounds (B-1) and (B-2) may be used as the catalyst component (B) alone or in combination of two or more.

The polymerization catalyst used for producing the higher α-olefin polymer (3) in the invention may contain an organoaluminum compound as a component (B) in addition to the components (A) and (B).

The organoaluminum compound of the component (B) may be a compound represented by the general formula (VII):
R¹⁶ᵥAlJ₃₋ᵥ (VII)
wherein R¹⁶ represents an alkyl group having 1 to 10 carbon atoms, J represents a hydrogen atom, an alkoxy group having 1 to 20 carbon atoms, an aryl group having 6 to 20 carbon atoms, or a halogen atom, and v represents an integer of 1 to 3.

Specific examples of the compounds represented by the general formula (VII) include trimethylaluminum, triethylaluminum, triisopropylaluminum, triisobutylaluminum, dimethylaluminum chloride, diethylaluminum chloride, methylaluminum dichloride, ethylaluminum dichloride, dimethylaluminum fluoride, diisobutylaluminum hydride, diethylaluminum hydride, and ethylaluminum sesquichloride, etc.

These organoaluminum compounds may be used alone or in combination of two or more.

The mole ratio of the catalyst component (A) to the catalyst component (B) is preferably 1:1 to 1:10,000, more preferably 1:5 to 1:2,000, further preferably 1:10 to 1:1,000.

The polymerization activity per the transition metal can be increased by using the catalyst component (B). However, in the case of using an excessively large amount of the organoaluminum compound, part of the organoaluminum compound is wasted, and a large amount of the organoaluminum compound disadvantageously remains in the polymer unfavorably.

In the production of the α-olefin polymer, at least one of the catalyst components may be supported on a suitable carrier.

The type of the carrier is not particularly limited, and the carrier may be an inorganic oxide carrier, other inorganic carrier, or an organic carrier. The carrier is particularly preferably an inorganic oxide carrier or the other inorganic carrier.

Specific examples of the inorganic oxide carriers include SiO₂, Al₂O₃, MgO, ZrO₂, TiO₂, Fe₂O₃, B₂O₃, CaO, ZnO, BaO, ThO₂, mixtures thereof such as silica alumina, zeolite, ferrite, and glass fibers, etc.

Among these inorganic oxide carriers, SiO₂ and Al₂O₃ are particularly preferred.

The inorganic oxide carrier may contain a small amount of a carbonate salt, a nitrate salt, a sulfate salt, etc.

The other inorganic carrier may be a magnesium compound represented by the general formula MgR¹⁷ₓX¹_{y}, such as MgCl₂ and Mg(OC₂H₅)₂, or a complex salt thereof, etc.

R¹⁷ represents an alkyl group having 1 to 20 carbon atoms, an alkoxy group having 1 to 20 carbon atoms, or an aryl group having 6 to 20 carbon atoms, X¹ represents a halogen atom or an alkyl group having 1 to 20 carbon atoms, x is 0 to 2, y is 0 to 2, and x+y=2.

When the magnesium compound contains a plurality of R¹⁷'s or X¹'s, they may be the same or different ones.

Examples of the organic carriers include polymers such as polystyrenes, styrene-divinylbenzene copolymers, polyethylenes, poly(1-butene)s, substituted polystyrenes, and polyarylates; starches; carbons; etc.

Preferred carriers for the production of the α-olefin polymer include MgCl₂, MgCl(OC₂H₃), Mg(OC₂H₅)₂, etc.

The average particle diameter of the carrier is generally 1 to 300 μm, preferably 10 to 200 μm, more preferably 20 to 100 μm, though the property of the carrier depends on the type and the production method thereof.

When the particle diameter is too small, the polymer disadvantageously contains a larger amount of finer powder. When the particle diameter is too large, coarse particles are increased in the polymer to reduce the bulk density and to clog a hopper.

The specific surface area of the carrier is generally 1 to 1,000 m²/g, preferably 50 to 500 m²/g. The pore volume of the carrier is generally 0.1 to 5 cm³/g, preferably 0.3 to 3 cm³/g.

When the specific surface area or the pore volume is without the above range, the catalytic activity is often lowered.

The specific surface area and the pore volume may be obtained, for example, from a volume of nitrogen gas absorbed according to a BET method (see, J. Am. Chem. Soc., 60, 309 (1983)).

When the inorganic oxide carrier is used, it is preferably calcined at a temperature between 150 and 1,000° C. generally, preferably 200 and 800° C.

In the case of using the carrier, it is preferred that at least one of the catalyst components (A) and (B) is supported on the carrier, and it is more preferred that both of the catalyst components (A) and (B) are supported.

The method for supporting at least one of the components (A) and (B) is not particularly limited. Examples of the methods include (1) a method of mixing at least one of the components (A) and (B) with the carrier; (2) a method of treating the carrier with an organoaluminum compound or a halogen-containing silicon compound, and mixing the carrier with at least one of the components (A) and (B) in an inert solvent; (3) a method of reacting the carrier with the component (A) and/or the component (B) and an organoaluminum compound or a halogen-containing silicon compound; (4) a method of supporting the component (A) or (B) on the carrier and then mixing the carrier with the component (B) or (A); (5) a method of mixing a contact reaction product of the components (A) and (B) with the carrier; (6) a method of carrying out a contact reaction of the components (A) and (B) in the presence of the carrier; etc.

The methods of (4), (5) and (6) may be carried out in the presence of the organoaluminum compound of the component (C).

Thus-obtained catalyst may be used in the polymerization in the solid state after distilling off the solvent or in the state of the reaction mixture.

In the production of the higher α-olefin polymer (3) of the invention, at least one of the components (A) and (B) may be supported on the carrier to produce the catalyst in the polymerization system.

For example, catalyst particles may be prepared by the steps of adding at least one of the components (A) and (B) and the carrier, adding the organoaluminum compound of the component (B) thereto if necessary, adding an olefin such as ethylene to the resulting mixture at the ordinary pressure to 2 MPa (gauge), and pre-polymerizing the olefin at −20 to 200° C. for 1 minute to 2 hours.

In the catalyst used for the production of the α-olefin polymer in the invention, the mass ratio of the compound (B-1) to the carrier is preferably 1:5 to 1:10,000, more preferably 1:10 to 1:500. The mass ratio of the compound (B-2) to the carrier is preferably 1:0.5 to 1:1,000, more preferably 1:1 to 1:50.

In the case of using two or more types of the components (B), the mass ratio of each component (B) to the carrier is preferably within the above range.

The mass ratio of the component (A) to the carrier is preferably 1:5 to 1:10,000, more preferably 1:10 to 1:500.

When the mass ratio of the component (B) [the compound (B-1) or the compound (B-2)] to the carrier or the mass ratio of the component (A) to the carrier does not fall within the above range, the catalytic activity is lowered in some cases.

The average particle diameter of the polymerization catalyst thus prepared is generally 2 to 200 μm, preferably 10 to 150 μm, particularly 20 to 100 μm. The specific surface area of the catalyst is generally 20 to 1,000 m²/g, preferably 50 to 500 m²/g.

When the average particle diameter is less than 2 μm, the fine powder content in the polymer is often increased. When the average particle diameter is more than 200 μm, the coarse particle content in the polymer often increases.

When the specific surface area is less than 20 m²/g, the catalytic activity tends to weaken. When the specific surface area is more than 1,000 m²/g, the bulk density of the polymer is reduced in some cases.

In the catalyst used for the production of the 1-butene-based polymer, the amount of the transition metal per 100 g of the carrier is generally 0.05 to 10 g, particularly preferably 0.1 to 2 g.

When the amount of the transition metal goes outside of the above range, the catalytic activity tends to be lowered.

By supporting the catalyst components on the carrier, an industrially useful polymer having a high bulk density and an excellent particle size distribution can be produced.

The polymerization method for producing the higher α-olefin polymer (3) used in the invention is not particularly limited, and may be a slurry polymerization method, a vapor phase polymerization method, a bulk polymerization method, a solution polymerization method, or a suspension polymerization method, etc. Particularly preferred methods are the slurry polymerization method and the vapor phase polymerization method.

The polymerization temperature is generally −100 to 250° C., preferably −50 to 200° C., more preferably 0 to 130° C.

The ratio of the catalyst to the starting material is preferably such that the mole ratio of the starting monomer/the component (A) is 1 to 10⁸, particularly preferably such that the mole ratio is 100 to 10⁵.

The polymerization time is generally 5 minutes to 10 hours, and the polymerization pressure is preferably ordinary pressure to 20 MPa (gauge), more preferably ordinary pressure to 10 MPa (gauge).

In the production of the α-olefin polymer used in the invention, hydrogen is preferably added to the reaction system to increase the polymerization activity.

The pressure of hydrogen is generally ordinary pressure to 5 MPa (gauge), preferably ordinary pressure to 3 MPa (gauge), more preferably ordinary pressure to 2 MPa (gauge).

In the case of using a polymerization solvent, the solvent may be an aromatic hydrocarbon such as benzene, toluene, xylene, and ethylbenzene; an alicyclic hydrocarbon such as cyclopentane, cyclohexane, and methylcyclohexene; an aliphatic hydrocarbon such as pentane, hexane, heptane, and octane; a halogenated hydrocarbon such as chloroform and dichloromethane; etc.

These solvents may be used alone or in combination of two or more. Further, a monomer such as an α-olefin may be used as the solvent.

The polymerization may be carried out without the solvent in some polymerization methods.

In the polymerization, pre-polymerization may be carried out in the presence of the polymerization catalyst described above.

For example, the pre-polymerization may be carried out by bringing a small amount of an olefin into contact with the solid catalyst components. However, the pre-polymerization method is not particularly restricted and may be a known one.

The olefin for the pre-polymerization is not particularly limited, and may be selected from the above-described olefins such as ethylene, α-olefins having 3 to 20 carbon atoms, and mixtures thereof. It is preferred that the same olefins are used in the pre-polymerization and the polymerization.

The pre-polymerization temperature is generally −20 to 200° C., preferably −10 to 130° C., more preferably 0 to 80° C.

In the pre-polymerization, an aliphatic hydrocarbon, an aromatic hydrocarbon, a monomer, etc. may be used as a solvent.

The aliphatic hydrocarbon solvent is particularly preferred among them. The pre-polymerization may be carried out with no solvents.

The pre-polymerization is preferably carried out under the conditions controlled such that the pre-polymerization product has a intrinsic viscosity [η] of 0.1 dL/g or more (measured at 135° C. in decalin), and the amount of the pre-polymerization product per 1 mmol of the transition metal component in the catalyst is 1 to 10,000 g, particularly 10 to 1,000 g.

The molecular weight of the polymer may be controlled by selecting the type and amount of each catalyst component, by selecting the polymerization temperature, or by polymerizing in the presence of hydrogen.

The polymerization may be carried out in the presence of an inert gas such as nitrogen.

The thermoplastic resin composition of the invention comprises 0.1 to 99.9% by mass of the thermoplastic resin (1) and 0.1 to 99.9% by mass of the higher α-olefin polymer (3).

The thermoplastic resin composition of the invention preferably comprises 30 to 98% by mass of the thermoplastic resin (1) and 70 to 2% by mass of the higher α-olefin polymer (3), more preferably comprises 50 to 95% by mass of the thermoplastic resin (1) and 50 to 5% by mass of the higher α-olefin polymer (3), and particularly preferably comprises 70 to 90% by mass of the thermoplastic resin (1) and 30 to 10% by mass of the higher α-olefin polymer (3).

When the content of the higher α-olefin polymer (3) is less than 0.1% by mass, the improvement of the physical properties, particularly the impact resistance, of the thermoplastic resin composition is lowered. When the content is more than 99.9% by mass, the resultant thermoplastic resin composition is poor in heat resistance.

Alternatively, the thermoplastic resin composition of the invention may comprise 0.1 to 99.9% by mass of the thermoplastic resin (1), more than 0 to not more than 99.8% by mass of the elastomer (2), and 0.1 to 99.9% by mass of the higher α-olefin polymer (3).

The thermoplastic resin composition preferably comprises 10 to 94% by mass of the thermoplastic resin (1), 5 to 70% by mass of the elastomer (2), and 1 to 30% by mass of the higher α-olefin polymer (3), more preferably comprises 35 to 88.5% by mass of the thermoplastic resin (1), 10 to 50% by mass of the elastomer (2), and 1.5 to 15% by mass of the higher α-olefin polymer (3), and particularly preferably comprises 52 to 83% by mass of the thermoplastic resin (1), 15 to 40% by mass of the elastomer (2), and 2 to 8% by mass of the higher α-olefin polymer (3).

When the content of the higher α-olefin polymer (3) is less than 0.1% by mass, the improvement of the physical properties, particularly the impact resistance, of the thermoplastic resin composition is lowered. When the content is more than 99.9% by mass, the resultant thermoplastic resin composition is poor in heat resistance.

When the thermoplastic resin composition does not contain the elastomer (2), the physical properties, particularly the impact resistance, of the composition is lowered. When the content of the elastomer (2) is more than 99.8% by mass, the composition is poor in rigidity.

For example, the thermoplastic resin composition of the invention may be prepared by the following methods.

(a) a method of melt-kneading the thermoplastic resin (1), the elastomer (2), and the higher α-olefin polymer (3);

(b) a method of producing the thermoplastic resin (1) and the higher α-olefin polymer (3) in the polymerization process in the presence of at least two catalyst components, and then melt-kneading the elastomer (2) therewith; or

(c) a method of dissolving and blending the thermoplastic resin (1), the elastomer (2), and the higher α-olefin polymer (3) in a common solvent.

The method for melt-kneading the thermoplastic resin (1), the elastomer (2), and the higher α-olefin polymer (3) may be selected from the publicly known methods.

An apparatus for the melt-kneading process may be a mixing roll mill, an intensive mixer, a Banbury mixer, a kneader, or a single- or twin-screw extruder.

A publicly known inorganic or organic filler may be added to the thermoplastic resin composition of the invention if necessary unless the filler ruins the advantageous effects of the invention.

The shape of the inorganic or organic filler is not particularly limited. The filler may be in any shape of particle, plate, rod, fiber, whisker, etc.

Examples of the inorganic fillers include oxides such as silica, diatomaceous earth, barium ferrite, alumina, titanium oxide, magnesium oxide, beryllium oxide, pumice, and pumice balloon; hydroxides such as aluminum hydroxide, magnesium hydroxide, and basic magnesium carbonate; carbonates such as calcium carbonate, magnesium carbonate, dolomite, and dawsonite; sulfates and sulfites such as calcium sulfate, barium sulfate, ammonium sulfate, and calcium sulfite; clay minerals, silicates, and organized derivatives thereof (organized clays) such as talc, clay, mica, asbestos, glass fibers, glass flakes, glass balloons, glass beads, calcium silicate, montmorillonite, bentonite, and kaolinite; carbons such as carbon black, graphite, carbon fibers, and hollow carbon; and other fillers such as molybdenum sulfide, boron fibers, zinc borate, barium metaborate, calcium borate, sodium borate, magnesium oxysulfate, and various metal fibers.

Examples of the organic fillers include shell fibers of husk, etc., wood flour, arboreous cotton, jute, paper pieces, cellophane pieces, aromatic polyamide fibers, cellulose fibers, nylon fibers, polyester fibers, polypropylene fibers, and thermosetting resin powders, etc.

These inorganic fillers and the organic fillers may be used alone or in combination of two or more.

In injection molding, talc, mica, calcium carbonate, and glass fibers are preferred among the above fillers, and talc is particularly preferred.

The size of the talc is preferably such that the average particle diameter is 1 to 8 μm and the average aspect ratio is 4 or more in view of the properties of the resulting molded article, including rigidity, impact resistance, scratch-whitening resistance, weld appearance, and gloss unevenness.

Talc obtained by a process grinding method is particularly preferable from the viewpoints of physical properties, rigidity, etc.

The amount of the inorganic or organic filler is 1 to 100 parts by mass per 100 parts by mass of the resin composition.

When the amount is less than 1 part by mass, the resulting molded article is often insufficient in rigidity. When the amount is more than 100 parts by mass, the weld strength, the weld appearance, and the gloss unevenness of the resulting molded article are deteriorated, and the impact resistance and the scratch-whitening resistance are reduced in some cases.

The amount of the inorganic or organic filler is preferably 3 to 60 parts by mass, particularly 5 to 40 parts by mass, per 100 parts by mass of the resin components from the viewpoints of the appearance, rigidity, impact resistance, scratch-whitening resistance, etc. of the molded article.

A known additive such as a crystal nucleating agent, an weathering stabilizer, an ultraviolet absorber, a light stabilizer, a heat stabilizer, an antistatic agent, a mold lubricant, a flame retardant, a synthetic oil, a wax, an agent for improving electrical properties, an antislipping agent, an antiblocking agent, a viscosity controlling agent, a color protection agent, an anticlouding agent, a lubricant, a pigment, a dye, a plasticizer, a softening agent, an age resistor, a hydrochloric acid absorbent, a chlorine scavenger, and an antioxidant may be added to the thermoplastic resin composition if necessary unless it ruins the advantageous effects of the invention.

The amount of a coloring agent is preferably 5 parts by mass or less, more preferably 3 parts by mass or less, per 100 parts by mass of the total of the resin components and the inorganic or organic filler.

When the amount is more than 5 parts by mass, the resultant molded article is likely to be poor in rigidity at a high temperature, and costly.

Examples of the stabilizers include phenol-based stabilizers, organic phosphite-based stabilizers, thioether-based stabilizers, hindered amine-based stabilizers, and higher fatty acid metal salts. The amount of the stabilizer may be 0.001 to 10 parts by mass per 100 parts by mass of the thermoplastic resin composition.

In the invention, the inorganic filler, the organic filler, and/or the additive may be blended with the thermoplastic resin composition by melt-kneading and granulating by using a single-screw extruder, a twin-screw extruder, a Banbury mixer, a kneader, a roll, etc.

The thermoplastic resin composition of the invention may be formed into a various molded article, a sheet, a film, or a fiber, by thermoforming, extrusion molding, profile extrusion molding, injection molding, compression molding, foam molding, hollow molding, powder molding, calender molding, kneading processing, or inflation molding, etc.

The invention will be described in more detail below with reference to Examples without intention of restricting the scope of the invention.

First of all, the methods for evaluating physical properties of an α-olefin polymer are described.

(1) DSC Measurement

(i) DSC Measurement of Higher α-Olefin Polymer (3)

By using a differential scanning colorimeter (DSC-7 made by Perkin-Elmer Corp.), a sample was kept at −30° C. under nitrogen for 5 minutes and then heated to 190° C. at 10° C./minute to obtain a melting endotherm curve. The temperature corresponding to the peak top of the maximum peak in the melting endotherm curve was defined as a melting point (TmD), and the heat quantity of the melting endotherm was defined as ΔH_{D} (J/g). Further, the sample was kept at 190° C. for 5 minutes, cooled to −30° C. at 5° C./minute, kept at −30° C. for 5 minutes, and then heated to 190° C. at 10° C./minute, to obtain a melting endotherm curve. The temperature corresponding to the peak top in the melting endotherm curve was defined as a melting point (Tm), and the heat quantity of the melting endotherm was defined as ΔH (J/g).

(ii) DSC Measurement of Thermoplastic Resin Composition

The measurement was carried out by using a differential scanning colorimeter (DSC-7 made by Perkin-Elmer Corp.) under nitrogen.

A sample was heated from the room temperature to 220° C. at 20° C./minute, and thus-obtained heat quantity of the melting endotherm was defined as ΔH_{Db} (J/g) and the temperature corresponding to the peak top was defined as a melting point TmDb (° C.). The sample was kept at 220° C. for 5 minutes, cooled to −30° C. at 20° C./minute, kept at −30° C. for 5 minutes, and heated to 220° C. at 20° C./minute, and thus-obtained heat quantity of the melting endotherm was defined as ΔH (J/g) and the temperature corresponding to the peak top was defined as a melting point Tm (° C.)

(iii) Apparatus and Conditions for GPC Measurement

The DSC measurement was carried out under the following conditions using the following apparatus. A weight average molecular weight (Mw), a number average molecular weight (Mn), and a molecular weight distribution (Mw/Mn) were obtained as the polystyrene conversion values from a calibration curve using a polystyrene standard.

Column: TOSO GMHHR-H(S)HT

Detector: RI detector WATERS 150 C for liquid chromatograph

Temperature: 145° C.

Solvent: 1,2,4-trichlorobenzene

Sample concentration: 2.2 mg/mL

(2) Measurement of Stereoregularity Index M2 (mol %)

The stereoregularity index M2 was obtained according to the method proposed in T. Asakura, M. Demura, and Y. Nishiyama, Macromolecules, 24, 2334 (1991).

Thus, the stereoregularity index M2 was obtained by utilizing a ¹³C-NMR spectrum, in which the division of signals of CH₂ carbons in side chain α-positions is dependent on the stereoregularity.

A polymer with a larger M2 has higher isotacticity.

The ¹³C-NMR spectrum was measured by using the following apparatus under the following conditions.

Apparatus: EX400 manufactured by JEOL Ltd.

Temperature: 130° C.

Pulse width: 45°

Integration: 1,000 times

Solvent: 90:10 (volume ratio) mixed solvent of 1,2,4-trichlorobenzene and deuterated benzene

The stereoregularity index M2 can be calculated in the following manner.

6 large absorption peaks of the mixed solvent are observed within the range of 127 to 135 ppm.

Among the 6 peaks, the 4th peak from the low magnetic field side is taken as a reference of chemical shift values and set as 131.1 ppm.

In this case, absorption peaks of the CH₂ carbons in the side chain α-positions are observed around 34 to 37 ppm.

The stereoregularity index M2 (mol %) is obtained using the equation:

$$M 2 = \frac{( integrated intensity in 36.2 to 35.3 ppm )}{( integrated intensity in 36.2 to 34.5 ppm )} ⨯ 100$$

(3) Measurement of Miscibility

A spin-lattice relaxation time (T₁) of a crystal phase of a thermoplastic resin (1) was measured by an inversion recovery method (a 180′-τ-90′ pulse method) using the following solid NMR measurement apparatus. The miscibility was evaluated by the degree of change of the spin-lattice relaxation time (T₁).

Apparatus: JNM-MU25 pulse NMR spectrometer manufactured by JEOL Ltd.

Nuclei measured: Hydrogen nuclei (¹H)

Frequency: 25 MHz

Temperature: 30° C.

90° pulse width: 2.0 microseconds

A spin-lattice relaxation time (T₁) and a spin-spin relaxation time (T₂) are generally known as relaxation times measured in relaxation phenomenon in NMR analysis.

The spin-lattice relaxation is a process in which the energy of the spins is transferred to the lattice. The spin-spin relaxation is a process in which the energy is dissipated due to the dipole-dipole interactions between the spins.

The spin-spin relaxation reflects extremely short-range interactions, and is remarkably more rapid than the spin-lattice relaxation to satisfy T₁>>T₂.

Thus, the T₂ process is concluded in the middle of the T₁ process.

When the components of the thermoplastic resin composition are spatially closer to each other and thus are more compatible with each other, the spin energy interchange between the components by the T₂ process is increased.

Thus, the spin energy state is changed depending on the interactions between the components before the energy is transferred from the spins to the lattice in the T₁ process.

As a result, the observed T₁ is changed. The larger the change of T₁ is, the higher the miscibility between the components is estimated to be.

In the invention, the miscibility was evaluated from the degree of the change of a relaxation rate, which is the reciprocal (1/T₁) of the relaxation time.

Practically the relaxation time T₁ can be obtained from the relation between a time (τ) and a magnetization M(τ) at the time. In the case of using a polypropylene-based resin as the thermoplastic resin (1), a relaxation component obtained in the longer side of τ corresponds to the spin-lattice relaxation time (T₁) of the crystal component of the polypropylene-based resin.

When the spin-lattice relaxation rate (1/T₁) of the crystal component of the polymer composed of the single thermoplastic resin (1) is represented by (1/T₁)₀, and the spin-lattice relaxation rate (1/T₁) of the crystal component of the thermoplastic resin (1) contained in the thermoplastic resin composition is represented by (1/T₁)_{A}, the ratio of them is defined as the degree of the change R.

Namely, R=[(1T₁)_{A}]/[(1/T₁)₀].

A larger degree of the change R means that the miscibility of the thermoplastic resin (1) to the higher α-olefin polymer (3) or the elastomer (2) is higher. Specifically, the change rate R is preferably 1.05 or more, more preferably 1.10 or more, particularly preferably 1.15 or more, further preferably 1.20 or more.

(4) Measurement of Film Impact Strength

The film impact strength of each sample was measured at the room temperature under conditions of a capacity of 30 kgf·cm and a ½-inch impact head by using a film impact tester made by Toyo Seiki Seisaku-Sho, Ltd.

### PRODUCTION EXAMPLE 1

(i) Preparation of Catalyst

(1) Production of 2-chlorodimethylsilylindene

Under a nitrogen gas stream, 50 mL of THF (tetrahydrofuran) and 2.5 g (41 mmol) of magnesium were introduced to a 1-L three-necked flask, and 0.1 mL of 1,2-dibromoethane was added thereto and stirred for 30 minutes to activate the magnesium.

Then, the solvent was removed, and 50 mL of THF was added to the residue.

To this was added dropwise over 2 hours a solution of 5.0 g (25.6 mmol) of 2-bromoindene in 200 mL of THF.

After the addition, the resultant mixture was stirred at the room temperature for 2 hours and cooled to −78° C. A solution of 3.1 mL (25.6 mmol) of dichlorodimethylsilane in 100 mL of THF was added to the mixture dropwise over 1 hour and stirred for 15 hours, and the solvent was distilled off.

The residue was subjected to extraction with 200 mL of hexane, and the solvent was distilled off to obtain 6.6 g (24.2 mmol) of 2-chlorodimethylsilylindene (94% yield).

(2) Production of (1,2′-dimethylsilylene)(2,1′-dimethylsilylene)bis(indene)

Under a nitrogen gas stream, 400 mL of THF and 8 g of 2-chlorodimethylsilylindene produced above were introduced to a 1-L three-necked flask and cooled to −78° C.

To the resultant solution was added 38.5 mL (38.5 mmol) of a 1.0 mol/L LiN(SiMe₃)₂ solution in THF dropwise.

The mixture was stirred at the room temperature for 15 hours, the solvent was distilled off, and the residue was subjected to extraction with 300 mL of hexane.

The solvent was distilled off to obtain 2.0 g (6.4 mmol) of (1,2′-dimethylsilylene)(2,1′-dimethylsilylene)bis(indene) (33.4% yield).

(3) Production of (1,2′-dimethylsilylene)(2,1′-dimethylsilylene)(indenyl)(3-trimethylsilylmethylindenyl)zirconium chloride

Under a nitrogen gas stream, 50 mL of ether and 3.5 g (10.2 mmol) of (1,2′-dimethylsilylene)(2,1′-dimethylsilylene)bis(indene) were introduced into a 200-mL Schlenk tube.

To this was added 12.8 mL of a 1.60 M hexane solution of n-butyllithium (n-BuLi) dropwise at −78° C.

The contact reaction was carried out at the room temperature for 8 hours, the solvents were distilled off, and the obtained solid was dried under reduced pressure to obtain 5.0 g of a white solid.

This solid was dissolved in 50 mL of THF, and thereto was added 1.4 mL of iodomethyltrimethylsilane dropwise at the room temperature.

10 mL of water was added to the resulting mixture, and the organic phase was extracted with 50 mL of ether.

The organic phase was dried, and the solvents were distilled off. To this was added 50 mL of ether, and 12.4 mL of a 1.60 M n-BuLi hexane solution was added thereto dropwise at −78° C.

The mixture was heated to the room temperature and stirred for 3 hours, and the ether was distilled off. The obtained solid was washed with 30 mL of hexane and dried under reduced pressure.

5.11 g of thus-obtained white solid was suspended in 50 mL of toluene, and thereto was added a suspension of 10 mL of toluene and 2.0 g (8.6 mmol) of zirconium tetrachloride prepared in another Schlenk tube.

The mixture was stirred at the room temperature for 12 hours, the solvents were distilled off, and the residue was washed with 50 mL of hexane.

The residue was recrystallized from 30 mL of dichloromethane to obtain 1.2 g of yellow crystallites of (1,2′-dimethylsilylene)(2,1′-dimethylsilylene)(indenyl)(3-trimethylsilylmethylindenyl)zirconium chloride (25% yield).

¹H-NMR (90 MHz, CDCl₃): δ −0.09 (s, —SiMe₃, 9H), 0.89, 0.86, 1.03, 1.06 (s, -Me₂Si—, 12H), 2.20, 2.65 (d, —CH₂—, 2H), 6.99 (s, CH, 1H), 7.0-7.8 (m, ArH, 8H).

(ii) Polymerization

A 1-L autoclave was heat-dried, and thereto were added 200 mL of heptane, 200 mL of 1-octadecene (C₁₈), 0.5 mmol of triisobutylaluminum, and 1 mmol of methylaluminoxane. Further, hydrogen was introduced into the autoclave at 0.03 MPa.

The resulting mixture was heated to 60° C. while stirring, and then 1 μmol of (1,2′-dimethylsilylene) (2,1′-dimethylsilylene)(3-trimethylsilylmethylindenyl)(indenyl)zirconium dichloride was added to the mixture, and polymerization was carried out for 30 minutes.

After the polymerization, the reaction mixture was heat-dried under a reduced pressure to obtain 25 g of a higher α-olefin polymer.

Results of measuring the physical properties of the obtained polymer are shown in Table 1.

The melting point (Tm) of the polymer was measured by the method described already, and as a result, the polymer showed one peak.

### PRODUCTION EXAMPLE 2

89 g of a higher α-olefin polymer was produced in the same manner as Production Example 1 except that the polymerization temperature was 30° C.

Results of measuring the physical properties of the obtained polymer are shown in Table 1.

The melting point (Tm) of the polymer was measured by the method described already, and as a result, the polymer showed one peak.

### EXAMPLES 1 to 4 and COMPARATIVE EXAMPLES 1 to 2

The following thermoplastic resins (1), elastomers (2), and higher α-olefin polymers (3) were used to prepare thermoplastic resin compositions. Their compositions are shown in Table 2.

The thermoplastic resin compositions were prepared in the following manner. A given amount of a thermoplastic resin (1), an elastomer (2), and a higher α-olefin polymer (3) were introduced to a flask such that the total mass of the components was 5 g, and 250 mL of o-dichlorobenzene was added thereto and stirred at 140° C. to dissolve the components.

The components were precipitated in methanol, and thus-obtained composition was air-dried and then vacuum-dried.

The composition was formed by melting compression molding at 230° C., and rapidly cooled with iced water, to obtain a 100-μm-thick sheet and a 200-μm-thick sheet.

The sheets were heat-treated at 60° C. for 24 hours in a high temperature bath to prepare samples.

The 200-μm-thick sheet was used for the solid NMR measurement, and the 100-μm-thick sheet was used for the film impact strength measurement.

(i)Thermoplastic Resin (1)

1a: Polypropylene made by Idemitsu Petrochemical Co., Ltd., J3000GP (homo PP, MI=30)

(ii)Elastomer (2)

2a: Plastomer made by The Dow Chemical Co., AFFINITY EG8150 (ethylene-octene-1 copolymer having a density of 0.87 g/cm³)

2b: Elastomer made by Mitsui Chemicals, Inc., TAFMER S4030 (propylene-ethylene copolymer having a density of 0.86 g/cm³)

2c: Elastomer made by Mitsui Chemicals, Inc., TAFMER BL2481 (butene-propylene copolymer having a density of 0.90 g/cm³)

(iii)Higher α-olefin polymer (3)

3a: Polymer of Production Example 1

3b: Polymer of Production Example 2

The results of the solid NMR measurement and the film impact strength measurement of the obtained sheets comprising the thermoplastic resin compositions are shown in Table 3.

Also the melting point (TmDb) and the melting endotherm (ΔH_{Db}) of each thermoplastic resin composition (1) obtained by the DSC measurement are shown in Table 3.

### PRODUCTION EXAMPLE 3

(i) Preparation of catalyst

Production of (1,2′-dimethylsilylene) (2,1′-dimethylsilylene)bis(3-trimethylsilylmethylindenyl)zirconium dichloride

Under a nitrogen gas stream, 2.5 g (7.2 mmol) of the (1,2′-dimethylsilylene)(2,1′-dimethylsilylene)-bis(indene) produced in Production Example 1 (2) and 100 mL of ether were added to a 200-mL Schlenk tube.

The mixture was cooled to −78° C., and thereto was added 9.0 mL of a 1.6 M hexane solution of n-butyllithium (n-BuLi) (14.8 mmol). The mixture was stirred at the room temperature for 12 hours.

The solvents were distilled off, and the obtained solid was washed with 20 mL of hexane and dried under reduced pressure to obtain a white solid of a lithium salt quantitatively.

In a Schlenk tube, 6.97 mmol of the lithium salt of (1,2′-dimethylsilylene)(2,1′-dimethylsilylene)-bis(indene) was dissolved in 50 mL of THF. 2.1 mL (14.2 mmol) of iodomethyltrimethylsilane was slowly added to the solution dropwise at the room temperature, and stirred for 12 hours.

Then, the solvent was distilled off, and washed with a saturated ammonium chloride solution after adding 50 mL of ether.

After the water phase was separated, the organic phase was dried to remove the solvent, thereby obtaining 3.04 g (5.9 mmol) of (1,2′-dimethylsilylene)(2,1′-dimethylsilylene)-bis(3-trimethylsilylmethylindene) (84% yield).

Next, under a nitrogen gas stream, 3.04 g (5.9 mmol) of the above (1,2′-dimethylsilylene) (2,1′-dimethylsilylene)-bis(3-trimethylsilylmethylindene) and 50 mL of ether were added to a Schlenk tube.

The mixture was cooled to −78° C., and thereto was added 7.4 mL of a 1.6 M n-BuLi hexane solution (11.8 mmol). The resulting mixture was stirred at the room temperature for 12 hours.

The solvents were distilled off, and the resultant solid was washed with 40 mL of hexane to obtain 3.06 g of a lithium salt as an ether adduct.

Results of ¹H-NMR measurement (90 MHz, THF-d₈) of the product were as follows: δ 0.04 (s, —SiMe₃, 18H), 0.48 (s, -Me₂Si—, 12H), 1.10 (t, —CH₃, 6H), 2.59 (s, —CH₂—, 4H), 3.38 (q, —CH₂—, 4H), 6.2-7.7 (m, Ar—H, 8H).

3.06 g of the obtained lithium salt was suspended in 50 mL of toluene under a nitrogen gas stream.

The suspension was cooled to −78° C., and to this was added dropwise a suspension of 1.2 g (5.1 mmol) of zirconium tetrachloride and 20 mL of toluene, which was cooled to −78° C. beforehand.

After the addition, the resulting liquid was stirred at the room temperature for 6 hours.

The solvents were distilled off from the reaction mixture, and the residue was recrystallized from dichloromethane to obtain 0.9 g (1.33 mmol) of yellow crystallites of (1,2′-dimethylsilylene)(2,1′-dimethylsilylene)-bis(3-trimethylsilylmethylindenyl)zirconium dichloride (26% yield).

The results of ¹H-NMR measurement (90 MHz, CDCl₃) of the product were as follows: δ 0.0 (s, —SiMe₃—, 18H), 1.02, 1.12 (s, -Me₂Si—, 12H), 2.51 (dd, —CH₂—, 4H), 7.1-7.6 (m, Ar—H, 8H).

(ii) Polymerization

A 1-L autoclave was heat-dried, and thereto were added 200 mL of 1-hexadecene (C₁₆), 1 mmol of triisobutylaluminum, 2 mmol of methylaluminoxane, 2 μmol of (1,2′-dimethylsilylene)(2,1′-dimethylsilylene)-bis(3-trimethylsilylmethylindenyl)zirconium dichloride. Then, hydrogen was introduced into the autoclave at 0.05 MPa, and the polymerization was carried out at the polymerization temperature of 60° C. for 120 minutes.

After the polymerization, the reaction product was precipitated in acetone and heat-dried under a reduced pressure to obtain 81 g of a higher α-olefin polymer.

Results of measuring the physical properties of the obtained polymer are shown in Table 1.

### EXAMPLE 5

A thermoplastic resin composition was prepared by mixing the polymer (3c) produced in Production Example 3 and the thermoplastic resin (1a) in the composition shown in Table 2 in the same manner as Example 1.

Results of solid NMR measurement of a sheet comprising the obtained thermoplastic resin composition are shown in Table 3.

### PRODUCTION EXAMPLE 4

A 1-L autoclave was heat-dried, and thereto was added 400 mL of a heptane solution containing 140 g of LINEARENE 2024 made by Idemitsu Petrochemical Co., Ltd. (a mixture mainly composed of α-olefins having 20, 22 or 24 carbon atoms). Further, hydrogen was introduced into the autoclave at 0.1 MPa, and the resultant was heated to the polymerization temperature of 60° C.

Then, 5 mmol of triisobutylaluminum, 5 μmol of (1,2′-dimethylsilylene)(2,1′-dimethylsilylene)-bis(3-trimethylsilylmethylindenyl)zirconium dichloride, and 25 μmol of dimethylanilinium tetrakis(pentafluorophenyl)borate were added to the resultant mixture, and the polymerization was carried out for 60 minutes.

After the polymerization, the product was precipitated in acetone and heat-dried under a reduced pressure to obtain 7 g of a higher α-olefin polymer.

Results of measuring the physical properties of the obtained polymer are shown in Table 1.

### EXAMPLE 6

A thermoplastic resin composition was prepared by mixing the polymer (4c) produced in Production Example 4 and the thermoplastic resin (1a) in the composition shown in Table 2 in the same manner as Example 1.

Results of solid NMR measurement of a sheet comprising the obtained thermoplastic resin composition are shown in Table 3.

As shown in Table 3, the change rates R of Examples 1, 5 and 6 are larger, and thus it is found that the higher α-olefin polymers (3) used in Examples 1, 5 and 6 are excellent in miscibility to the thermoplastic resin (1).

Further, the change rate R of Example 2 is larger than that of Comparative Example 2, and it is clear from the results that the higher α-olefin polymer (3) acts to promote the miscibility between the thermoplastic resin (1) and the elastomer (2).

TABLE 1

| | Production | Production | Production | Production |
|---|---|---|---|---|
| | Example 1 | Example 2 | Example 3 | Example 4 |
| Mw (PS | 152,000 | 361,000 | 113,000 | 72,500 |
| conversion) | | | | |
| Mw/Mn | 1.80 | 1.86 | 1.83 | 1.62 |
| TmD ° C. | 42.6 | 44.0 | 23.0, 37.7 | 49.4 |
| ΔH_{D} J/g | 82.8 | 82.8 | 76.1 | 91.1 |
| Tm ° C. | 41.1 | 40.7 | 28.0 | 48.1 |
| ΔH J/g | 79.1 | 84.6 | 64.4 | 85.9 |
| M2 mol % | 68.2 | 60.2 | 69.8 | 56.7 |

TABLE 2

| | Thermoplastic | | | | Higher α-olefin | |
|---|---|---|---|---|---|---|
| | resin (1) | | Elastomer (2) | | polymer (3) | |
| | Type | % by mass | Type | % by mass | Type | % by mass |
| Example 1 | 1a | 70.0 | — | — | 3a | 30.0 |
| Example 2 | 1a | 70.0 | 2a | 25.0 | 3a | 5.0 |
| Example 3 | 1a | 70.0 | 2b | 22.5 | 3a | 7.5 |
| Example 4 | 1a | 70.0 | 2c | 25.0 | 3b | 5.0 |
| Example 5 | 1a | 70.0 | — | — | 3c | 30.0 |
| Example 6 | 1a | 70.0 | — | — | 4c | 30.0 |
| Comparative | 1a | 100.0 | — | — | — | — |
| Example 1 | | | | | | |
| Comparative | 1a | 70.0 | 2a | 30.0 | — | — |
| Example 2 | | | | | | |

TABLE 3

| | | | | Thermoplastic | |
|---|---|---|---|---|---|
| | | | | resin (1) | |
| | | | | | Heat |
| | | | | | quantity of |
| | | | Film impact | | Melting |
| | T₁ | | strength | Melting | endotherm |
| | (msec) | R | (kJ/M) | point (° C.) | (J/g) |
| Example 1 | 306 | 1.16 | 7.0 | 162.0 | 63.0 |
| Example 2 | 289 | 1.23 | 8.9 | 165.0 | 63.7 |
| Example 3 | 320 | 1.11 | 9.0 | 161.6 | 64.2 |
| Example 4 | 306 | 1.16 | 9.4 | 163.0 | 63.3 |
| Example 5 | 262 | 1.35 | — | — | — |
| Example 6 | 303 | 1.17 | — | — | — |
| Comparative | 355 | 1.00 | 2.4 | 164.0 | 90.4 |
| Example 1 | | | | | |
| Comparative | 311 | 1.14 | 3.8 | 164.0 | 63.5 |
| Example 2 | | | | | |

### INDUSTRIAL APPLICABILITY

According to the present invention, there is provided a thermoplastic resin composition having excellent mechanical properties including high elastic modulus and impact strength without impairing excellent heat resistance and mold workability.

1. A thermoplastic resin composition comprising a thermoplastic resin (1) in an amount of 0.1 to 99.9% by mass and a higher α-olefin polymer (3) containing 50 mol % or more of an α-olefin having 10 or more carbon atoms in an amount of 0.1 to 99.9% by mass.

2. A thermoplastic resin composition comprising a thermoplastic resin (1) in an amount of 0.1 to 99.9% by mass, an elastomer (2) in an amount of exceeding 0% by mass and up to 99.8% by mass, and a higher α-olefin polymer (3) containing 50 mol % or more of an α-olefin having 10 or more carbon atoms in an amount of 0.1 to 99.9% by mass.

3. The thermoplastic resin composition according to claim 1 or 2, wherein the higher α-olefin polymer (3) has a stereoregularity index M2 of 50 mol % or more.

4. The thermoplastic resin composition according to claim 1 or 2, wherein the higher α-olefin polymer (3) has a weight average molecular weight (Mw) of 1,000 to 10,000,000 and a molecular weight distribution (Mw/Mn) of 4.0 or less, measured by the GPC method.

5. The thermoplastic resin composition according to claim 1 or 2, wherein the higher α-olefin polymer (3) has one melting point (Tm) of 0 to 100° C.

6. The thermoplastic resin composition according to claim 1 or 2, wherein the higher α-olefin polymer (3) is obtained by polymerizing the α-olefin having 10 or more carbon atoms in the presence of a polymerization catalyst component comprising a transition metal compound (A) represented by the following general formula (I) and at least one component (B) selected from a compound (B-1) capable of reacting with the transition metal compound (A) or a derivative thereof to form an ionic complex and an aluminoxane compound (B-2): 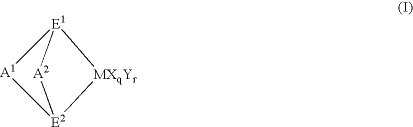
wherein M represents a metal atom among Groups 3 to 10 and the lanthanum series of the Periodic Table; E¹ and E² are ligands selected from the group of a substituted cyclopentadienyl group, an indenyl group, a substituted indenyl group, a heterocyclopentadienyl group, a substituted heterocyclopentadienyl group, an amide group, a phosphide group, a hydrocarbon group, or a silicon-containing group which form a structure cross-linked through A¹ and A² and they may be the same or different; X represents a σ-bonding ligand which may be a plurality of the same or different X's, and X may be cross-linked with another X, E¹, E², or Y;
Y represents a Lewis base, which may be a plurality of the same or different Y's, and Y may be cross-linked with another Y, E¹, E², or X; A¹ and A² are the same or different divalent cross-linking groups for linking the 2 ligands, and independently represent a hydrocarbon group having 1 to 20 carbon atoms, a halogen-containing hydrocarbon group having 1 to 20 carbon atoms, a silicon-containing group, a germanium-containing group, a tin-containing group, —O—, —Co—, —S—, —SO₂—, —Se—, —NR¹—, —PR¹—, —P(O)R¹—, —BR¹—, or —AlR¹—, in which R¹ represents a hydrogen atom, a halogen atom, a hydrocarbon group having 1 to 20 carbon atoms, or a halogen-containing hydrocarbon group having 1 to 20 carbon atoms which may be the same or different;
q represents an integer of 1 to 5 of [(valence of M)−2]; and r represents an integer of 0 to 3.

7. A molded article comprising the thermoplastic resin composition according to claim 1 or 2.

8. A sheet or a film comprising the thermoplastic resin composition according to claim 1 or 2.
